(19) United States
(12) Patent Application Publication
(10) Pub. No.: US 2005/0243983 A1
(43) Pub. Date: Nov. 3, 2005

(54) Modems

(75) Inventor: Stephen James Causier, Bristol (GB)

Correspondence Address: James E. Bradley;Bracewell & Patterson, L.L.P., P.O. Box 61389, Houston, TX, 77208-1389, US

(73) Assignee: VETCO GRAY CONTROLS LIMITED

(21) Appl. No.: 11/036,002

(22) Filed: Jan. 14, 2005

(30) Foreign Application Priority Data
May 1, 2004 (GB) 0409862.0

(51) Int. Cl. H04M 11/00

(52) U.S. Cl. 379/93.01; 379/93.28

(57) ABSTRACT

A modem for receiving and transmitting data from and to a conductor comprises an output drive for transmitting data to the conductor, a receiver for receiving data from the conductor and impedance matching means for matching the impedance of the receiver input with the impedance of the conductor, wherein the gain of the output drive, the receiver gain and the impedance of the receiver input are all adjustable.

### CROSS-REFERENCE TO RELATED APPLICATION

This application claims the benefit of United Kingdom Patent Application No. 0409862.0, filed on May 1, 2004, which hereby is incorporated by reference in its entirety.

### TECHNICAL FIELD OF THE INVENTION

This invention concerns a modem suitable for use in a multidrop configuration.

### BACKGROUND OF THE INVENTION

Underwater fluid or gas extraction systems, for example subsea oil extraction installations, typically include a Master Control Station (MCS) which is often located on the shore and underwater well head complexes. Communication between the MCS and the well heads is typically effected by the use of fibre optic technology, for example as described in GB 2 396 086 and U.S. patent application Ser. No. 10/726,674. The fibre optic cables are generally incorporated into the cables or umbilicals interfacing the two sites and these distances can typically be in excess of 40 km. There is a current trend for the need for communication between a Central Distribution Unit (CDU) and the well heads, offset from the CDU, where the distances involved are usually less than 40 km. The CDU for such systems can be shore-based, or located on a platform or vessel. Although fibre optic technology is able to meet such needs, the continuation of optical fibres to each well head is expensive. The alternative is to transceive data via wires between the CDU and the well heads using a modem at each end. It is even more desirable to transceive data superimposed on the power supply cables which have to be included in the umbilical, using modems designed for this purpose, i.e. Communications Superimposed On Power (COP).

However, there are two major problems to be overcome. Firstly, the development of fluid and/or gas extraction systems has resulted in more offset well heads from the CDU and at greater distances. As a result of this and the increased desirability of more sophisticated well head monitoring, there is a substantial increase of data to be transmitted, over greater distances. The second problem is that if the communication is via the power cable, then to avoid additional wires the modem system has to be multidrop, as opposed to less efficient point to point systems. In conventional multidrop configurations using existing modems, the distances between modems are relatively short, for example within a building, such that the variation of signal level at each modem is within the dynamic range of the modem design. For subsea applications involving wells offset from the CDU however, the difference in the distances between modems is substantial. For example, the modems at the master control station may be 5 km from the modems at the CDU, with further modems at offset wells which could be 5 to 20 km away. In consequence, the signal levels at the modems will be substantially different. In the above example, a master modem at the control station may have to transmit at full power to reliably communicate with a slave modem at the furthest offset well, 30 km away. This will result in the signal level at a slave modem at the CDU, only 5 km away from the master modem, totally swamping the modem input, i.e. the signal level will be well above the dynamic range of its input. Thus, although the prior art modems can operate in multidrop mode they are unable to handle a large variation of distance between them.

Modems that can transmit over distances of up to 40 km via the noisy medium of a power cable, with data rates as high as 115K bits per second exist, such as those described in U.S. Pat. Nos. 5,727,004 and 4,815,106 filed by Adaptive Networks Inc. However, these modem designs are not capable of operating under these more severe conditions in a multidrop system arrangement with large variations of distance between modems and where long offsets are required.

### SUMMARY OF THE INVENTION

In accordance with a first aspect of the present invention there is provided a modem for receiving and transmitting data from and to a conductor, comprising an output drive for transmitting data to the conductor, a receiver for receiving data from the conductor and impedance matching means for matching the impedance of the receiver input with the impedance of the conductor, wherein the gain of the output drive, the receiver gain and the impedance of the receiver input are all adjustable.

Preferably, the receiver input is complementary.

Advantageously, at least one output current amplifier with pre-emphasis is included in the output drive.

The impedance of the receiver input may be adjusted by switchably connecting at least one resistance across the receiver input. In this case, an electronic switch for connecting said at least one resistance may be provided.

Preferably, the output drive comprises a programmable amplifier, the gain of the output drive being adjustable by adjusting the amplifier.

Preferably, the output drive comprises alternatively selectable parallel and complementary connections, the voltage output of the output drive being adjusted by connecting one of said parallel and complementary connections to the output.

The output drive and receiver input may be galvanically isolated from the other modem electronics. The galvanic isolation may be provided by opto-isolators and or transformers.

The modem may include an internal control bus of a first format. In this case, means for converting the control bus of the first format to a different format for external connection may be included.

Advantageously, the data received by the conductor is superimposed on a power supply.

According to a second aspect of the invention, there is provided a multidrop modem network comprising a plurality of such modems.

According to a third aspect of the invention, there is provided an underwater installation including such a multidrop modem network.

Examples of the present invention can provide a copper wire modem that is able to transceive over distances up to about 40 km (depending on cable type) with a data rate of up to about 115K bits per second, and communicate via a single power cable in a multidrop configuration with large differences of distance between modems.

### BRIEF DESCRIPTION OF THE DRAWINGS

The invention will now be described by way of example with reference to the following figures, in which:—

FIG. 1 shows a typical communications arrangement for a fluid extraction installation according to an example of the invention; and

FIG. 2 shows a diagrammatic layout of a modem according to an example of the invention.

### DETAILED DESCRIPTION OF THE PREFERRED EMBODIMENT

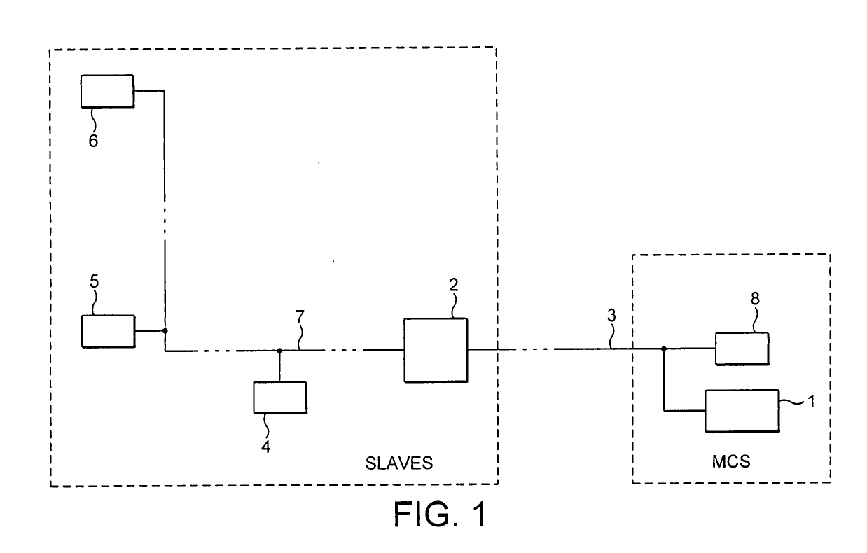

FIG. 1 shows a typical communications arrangement between a Master Control Station (MCS) and a complex of fluid extraction subsea wells, serviced by a Central Distribution Unit (CDU) 2. Electric power is transmitted from a power source 1 located at the MCS to the CDU2 via an umbilical 3, and is continued to offset wells 4, 5 and 6 via an umbilical 7. (Note that three offset wells are shown by way of example only, but such an arrangement could accommodate in excess of two hundred and fifty slave modems at various offsets communicating via DC or AC power systems.)

At the MCS, a single master modem 8, as stated above, can host in excess of two hundred and fifty slaves, and is connected to the power line passing through the umbilical 3 and on through the umbilical 7. By using programmable message preambles, multiple master modems can operate down the same umbilical on separate conductors without suffering destructive crosstalk. Each modem has a two wire interface and can be coupled to DC or AC power lines. At the well tree end of the system, i.e. the well complex, slave modems are connected across the power line at each tree. Thus the master modem 8 at the MCS is connected via the power line umbilicals to the modems at the well trees, including the offset wells, in a multidrop configuration.

Typically, the impedance of the power line presented to the modem frequency spectrum used (typically about 45 kHz to about 450 kHz) is in the order of 100 ohms. If a multiplicity of conventional modems were to be connected across the same transmission line, there would be little chance of an impedance match to the line, no opportunity to increase the output drive voltage or the receiver sensitivity to accommodate the additional load of many modems, and no facility to eliminate common mode crosstalk between the modems. As a result of these limitations, conventional modems are unsuitable in a multidrop configuration.

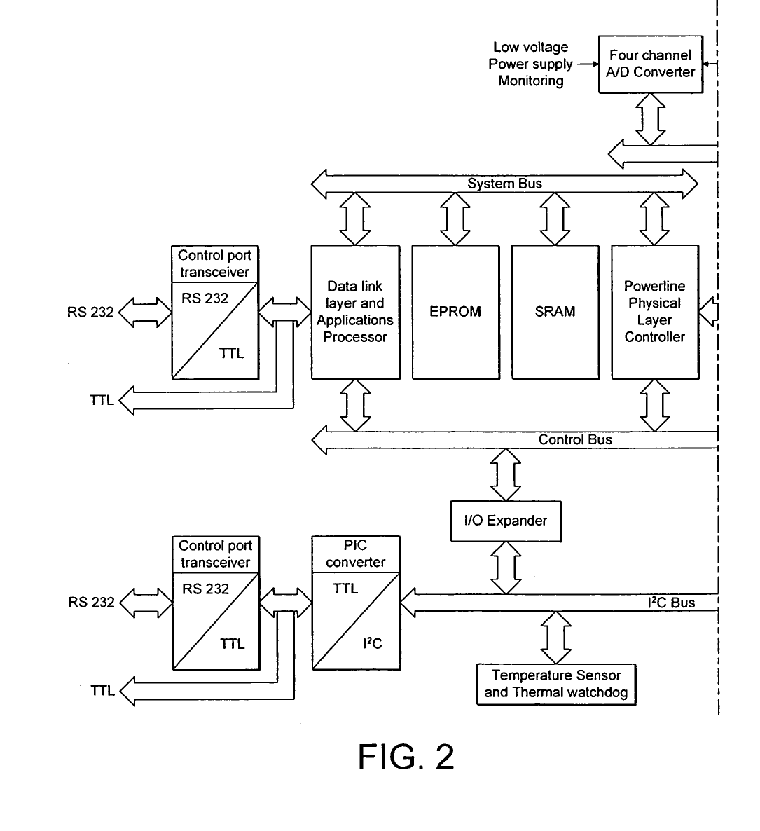

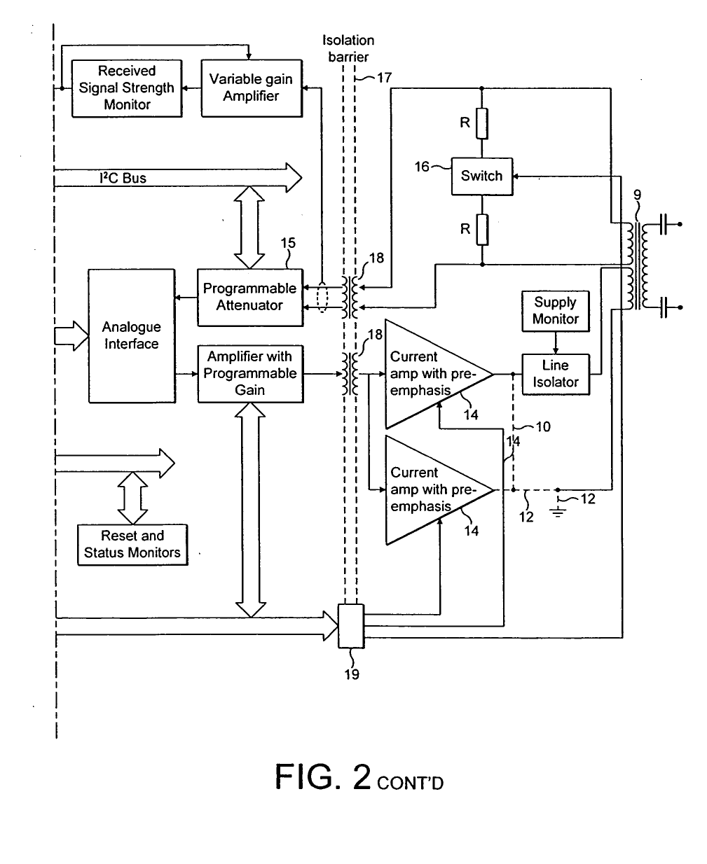

FIG. 2 shows the internal configuration of a modem in accordance with an example of the present invention for use with a COP system, with arrows showing the signal flow direction. In particular, the modem shows a number of inventive features not present in conventional, proprietary modems, as will be discussed below.

The modem receiver input and output drive are connected to the power line via two primaries of a trifilar transformer 9, the receiver input being connected at the top as shown and the output drive being connected at the bottom as shown, whose secondary is capacitively coupled to the power line (not shown). The receiver input and output driver electronics are galvanically isolated from the rest of the modem electronics as shown at 17. The galvanic isolation is a feature not known from conventional modems which reduces common mode crosstalk, and as shown is provided by transformers 18 in both the receiver Rx and transmission Tx paths, and by opto-isolation 19 of the control bus.

The modem electronics shown to the left of the galvanic isolation barrier 17 are, with the exceptions of the control port transceivers and PIC converter on the far left and programmable amplifier 13 and attenuator 15, known in conventional modems and so will not be discussed at length here.

The receiver input is complementary to interference signals and common mode rejection, and adjustment of the receiver sensitivity or gain is achieved by the programmable attenuator 15. Neither of these features is known from conventional modems.

In order to match the receiver input to the power line impedance, an electronic switch 16, such as a FET, is incorporated which connects series resistances R across the line. The resistances R may typically be about 47 ohm, which in conjunction with the few ohms resistance of the switch 16 provides the required matching resistance of about 100 ohms when connected (i.e. when switch 16 is activated). The resistances are generally only connected on the modems that are at the ends of the line, i.e. the master and most distant slave (modems 8 and 6 respectively in FIG. 1).

The output drive may be selectively connected in either a parallel or complementary configuration. In the conventional parallel configuration, links 10 and 12 are connected and link 11 removed. In the complementary configuration, links 10 and 12 are disconnected, link 11 connected and the phase of one the output amplifiers 14 is reversed. The complementary configuration doubles the voltage output of the drive in comparison with the parallel configuration. This provides a much simpler arrangement to adjust the output to suit the application than the alternative of changing the transformer 9 design, i.e. the turns ratio of the transformer, to suit.

Furthermore, the output power drive level or gain can be adjusted by control of the programmable amplifier 13. This enables minimisation of the system power consumption, which is a major cost factor bearing in mind the long lengths of the power cable and the thermal dissipation within a subsea vessel. Typically the output power is controllable in steps of about 100%, 60%, 40% and 25%. It should be noted that conventional point to point modems use Automatic Gain Control (AGC) to adjust the transmitter power level to suit the line conditions. Normally such systems transmit data seamlessly. However, the effect of AGC in long lines such as 40 km and multidrop configuration causes the first part of a transmitted message to be lost. The reason for this is that AGC systems start a message transmission at low drive amplitude and then ramp-up the amplitude during the transmission. A solution to this problem is to lengthen the preamble prior to data transmission. However, when data is not transmitted seamlessly but instead as individual packages, each of which requiring a preamble in front of them, a large percentage of the transmission time is taken up by the preambles, thus wasting effective bandwidth of the system. Thus with a multidrop configuration over long lines the requirement is to maintain a predefined transmit amplitude throughout the entire message. Thus in the present embodiment AGC is dispensed with and replaced with a full drive output.

Pre-emphasis is included in the output current amplifiers 14. This lifts the output amplitude with increase in frequency in order to compensate for the increase in attenuation of the cable with increase of frequency.

In use, selection or adjustment of the line matching impedance by operating switch 16, the programmable receiver gain and programmable output gain are made via the control bus. The control signals for this bus, at the subsea end of the system, are provided by the processing within a subsea electronics module within a subsea control module mounted on the well tree, which also controls the fluid extraction process. The modem control and data ports typically conform to the RS232 format, whereas the modem's internal control bus interface may be of a different format, for example I²C (developed by Philips Electronics). In the embodiment shown therefore, a Programmable Integrated Circuit (PIC) is provided to convert I²C to TTL (Transformer Transformer Logic), with a further conversion to RS232. Serial ports for both RS232 and TTL are therefore provided. This allows the modem to be configured once installed into the subsea vessel.

A multiplicity of modems may be set up to provide optimum operating conditions and reliable communication. The normal technique is to switch the matching resistances in circuit on the modems at the extreme ends of the system, e.g. master modem 8 and slave modem 6, using switch 16, with the remaining modems left with their switches 16 open, i.e. with high impedance inputs. Using a signal strength meter, the receiver and output gains are then adjusted to achieve optimum receive sensitivities and transmit drive levels, with a test message, to suit the system operating conditions. Once the system is set up, no further adjustment is necessary, i.e. “set and forget”.

The invention therefore permits communication via noisy power lines between a multiplicity of modems connected to the same long distance power line in a multidrop arrangement. This enables communication between an MCS and a multiplicity of well trees, where the variation in distance between them is large, to be achieved via a single power line and thus avoids the substantial costs of having to provide additional wires through the umbilical to handle communication to each well, which the conventional point to point system would require.

Although the invention has been described with reference to the embodiment above, there are many other modifications and alternatives possible within the scope of the claims. For example, in the embodiment shown, the maximum distance between the MCS and the furthest well is less than about 40 km, so that the total communication system can be implemented via the power lines using this invention. In other cases, where the MCS is much further away from the CDU and communication is provided by more expensive fibre optics, extension of the communication from the CDU to wells offset from the complex may then be facilitated by COP using the modem of the present invention.

Of course, while the modem of the present invention has been described for use in an underwater environment, it is suitable for many other applications including land-based communications systems.

1. A modem for receiving and transmitting data from and to a conductor, comprising an output drive for transmitting data to the conductor, a receiver for receiving data from the conductor and impedance matching means for matching an impedance of a receiver input with an impedance of the conductor, wherein a gain of the output drive, a receiver gain and the impedance of the receiver input are adjustable.

2. The modem according to claim 1, wherein the receiver input is complementary.

3. The modem according to claim 1, wherein the output drive further comprises at least one output current amplifier with pre-emphasis.

4. The modem according to claim 1, wherein the impedance of the receiver input is adjusted by switchably connecting at least one resistance across the receiver input.

5. The modem according to claim 4, further comprising an electronic switch for connecting said at least one resistance.

6. The modem according to claim 1, wherein the output drive further comprises a programmable amplifier, the gain of the output drive being adjustable by adjusting the amplifier.

7. The modem according to claim 1, wherein the output drive further comprises selectable parallel and complementary connections, a voltage output of the output drive being adjustable by connecting one of said parallel and complementary connections to the output.

8. The modem according to claim 1, wherein the output drive and receiver input are galvanically isolated from the other modem electronics.

9. The modem according to claim 8, wherein the galvanic isolation of the output drive and the receiver input from the other modem electronics is provided by opto-isolators.

10. The modem according to claim 8, wherein the galvanic isolation of the output drive and the receiver input from the other modem electronics is provided by transformers.

11. The modem according to claim 8, wherein the galvanic isolation of the output drive and the receiver input from the other modem electronics is provided by opto-isolators and transformers.

12. The modem according to claim 1, further comprising an internal control bus of a first format.

13. The modem according to claim 12, further comprising means for converting the control bus of the first format to a different format for external connection.

14. The modem according to claim 1, wherein the data received by the wire is superimposed on a power supply.

15. A multidrop modem network comprising a plurality of modems for receiving and transmitting data from and to a conductor in electrical communication with each other, each of the plurality of modems comprising an output drive for transmitting data to the conductor, a receiver for receiving data from the conductor and impedance matching means for matching an impedance of a receiver input with an impedance of the conductor, wherein a gain of the output drive, a receiver gain and the impedance of the receiver input are adjustable.

16. An underwater installation comprising a multidrop modem network associated with a plurality of subsea structures, the mutlidrop modem network including a plurality of modems for receiving and transmitting data from and to a conductor in electrical communication with each other, each of the plurality of modems comprising an output drive for transmitting data to the conductor, a receiver for receiving data from the conductor and impedance matching means for matching an impedance of a receiver input with an impedance of the conductor, wherein a gain of the output drive, a receiver gain and the impedance of the receiver input are adjustable.
